(19) United States
(12) Patent Application Publication
(10) Pub. No.: US 2014/0185547 A1
(43) Pub. Date: Jul. 3, 2014

(54) WIRELESS COMMUNICATION APPARATUS AND METHOD

(71) Applicant: KABUSHIKI KAISHA TOSHIBA, Tokyo (JP)

(72) Inventors: Ryoko MATSUO, Tokyo (JP); Tomoko ADACHI, Kawasaki-shi (JP); Tomoya TANDAI, Tokyo (JP)

(21) Appl. No.: 14/140,390

(22) Filed: Dec. 24, 2013

(30) Foreign Application Priority Data
Dec. 27, 2012 (JP) 2012-285118

(51) Int. Cl. H04W 74/04

(52) U.S. Cl. CPC H04W 74/04
USPC 370/329

(57) ABSTRACT

In general, according to one embodiment, there is provided a wireless communication apparatus used for asymmetrical communication, in which frame transmission at a first interval and frame transmission at a second interval longer than the first interval are performed. The apparatus includes a receiver, an interval controller, and a transmitter. The receiver receives a frame for which a flag requesting transmission of an acknowledgement is set. The interval controller changes the first interval to a third interval longer than the second interval in response to reception of the frame. The transmitter performs frame transmission at the third interval.

### CROSS-REFERENCE TO RELATED APPLICATIONS

This application is based upon and claims the benefit of priority from Japanese Patent Application No. 2012-285118, filed Dec. 27, 2012, the entire contents of which are incorporated herein by reference.

### FIELD

Embodiments described herein relate generally to a wireless communication apparatus and method.

### BACKGROUND

Wireless LAN conventionally employs access control according to a CSMA/CA method. Wireless communication apparatuses each measure and detect a possessing state of a wireless channel before using the wireless channel. As the wireless communication apparatuses each randomly set backoff before the wireless communication apparatuses each perform transmission. Supposing short-distance communication of about several ten centimeter, only wireless communication apparatuses included in a communication range thereof influence a wireless band. Therefore, an access control method which is more efficient than random backoff control is expected for short-distance communication.

Where short-distance communication as described above is supposed, transmission/reception of signals is supposed to be performed by one-to-one wireless communication. Random backoff is performed at the time of transmitting a control signal until establishment of connection.

Transmission/reception is performed at constant intervals without backoff after establishment of connection (for example, SIFS or DIFS in the IEEE802.11 wireless LAN).

There has been proposed a method for avoiding a collision between a wireless communication apparatus (hereinafter referred to as an “initiator”) which transmits a connection request and a wireless communication apparatus (hereinafter referred to as a “responder”) which receives the connection request, and for simultaneously prioritizing the initiator by changing a constant period given to each of the initiator and the responder. The initiator is given an initiator IFS (IIFS), and the responder is given a responder IFS (RIFS). Further, IIFS<RIFS is set. In this method, the initiator is preferentially given an opportunity to transmit a signal by providing a relatively short signal transmission interval in comparison with the responder.

### BRIEF DESCRIPTION OF THE DRAWINGS

FIG. 1 is a schematic diagram of a wireless system according to an embodiment;

FIG. 2 shows an example of asymmetrical access in one-to-one wireless communication;

FIG. 3 shows an example in which frame transmission is suspended for a constant period;

FIGS. 4A and 4B are a sequence chart of communication control according to the first embodiment;

FIG. 5 is a diagram showing a configuration of a wireless communication apparatus according to the first embodiment;

FIG. 6 shows an example of interfering insertion;

FIGS. 7A and 7B are a sequence chart of communication control according to the second embodiment;

FIGS. 8A and 8B are a sequence chart of communication control according to the fourth embodiment;

FIGS. 9A and 9B are a sequence chart of communication control according to the fifth embodiment;

FIGS. 10A and 10B are a sequence chart of communication control according to the sixth embodiment;

FIG. 11 is a diagram showing a configuration of a wireless communication apparatus according to the tenth embodiment; and

FIG. 12 is a diagram showing a configuration of a wireless communication apparatus according to the sixteenth embodiment.

### DETAILED DESCRIPTION

In general, according to one embodiment, there is provided a wireless communication apparatus used for asymmetrical communication, in which frame transmission at a first interval and frame transmission at a second interval longer than the first interval are performed. The apparatus includes a receiver, an interval controller, and a transmitter. The receiver receives a frame for which a flag requesting transmission of an acknowledgement is set. The interval controller changes the first interval to a third interval longer than the second interval in response to reception of the frame. The transmitter performs frame transmission at the third interval.

Hereinafter, embodiments will be described with reference to the drawings.

### First Embodiment

The first embodiment describes that a responder or a wireless communication apparatus being set to RIPS inserts a TCPACK transmission request (AppTxreq) into a frame transmission request signal (CNL_DATA.request) from a CNL user (Connection Layer user Layer: connected user layer) to a CNL (Connection Layer: connected layer), and that an initiator which has received an ACK frame including AppTxreq or a wireless communication apparatus being set to an IIFS sets a LIFS as a signal transmission interval to next signal transmission.

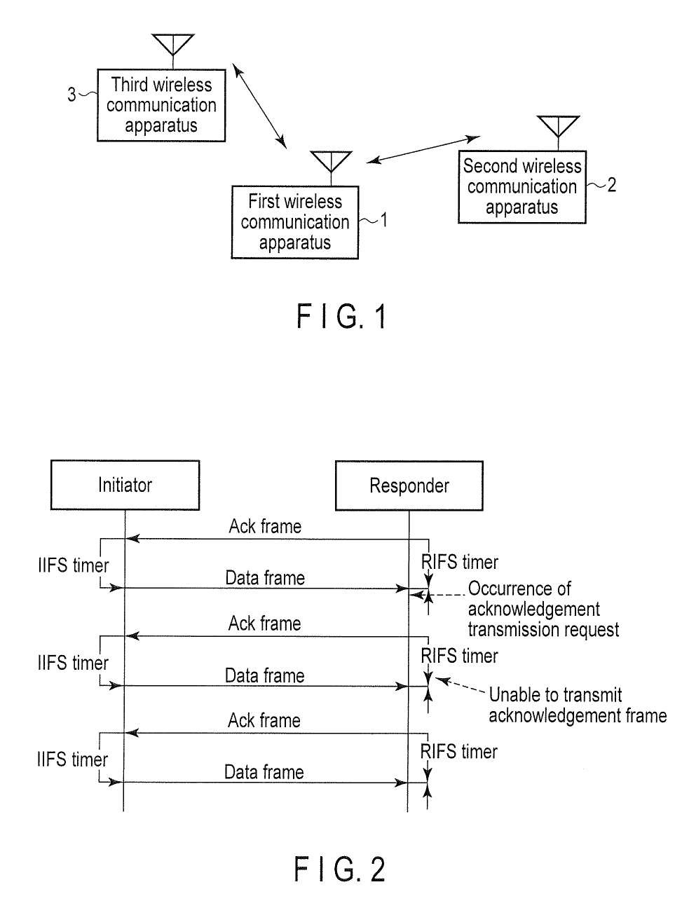

Outline of a wireless system according to the embodiment will now be described with reference to FIG. 1. The system according to FIG. 1 comprises first to third wireless communication apparatuses 1 to 3. In this wireless system, a distance between one another of the wireless communication apparatuses is supposed to be about several ten centimeter. In case of such short distance communication, a single wireless communication apparatus can be connected only to several wireless communication apparatuses at most. In the example of FIG. 1, the number of wireless communication apparatuses which the wireless system comprises is three. This number is not restrictive but two to five wireless communication apparatuses are available. In the example of FIG. 1, the first wireless communication apparatus 1 and the second wireless communication apparatus 2 make wireless communication. In addition, the first wireless communication apparatus 1 and the third wireless communication apparatus 2 make wireless communication as well. A description below will be made with reference to wireless communication between the first wireless communication apparatus 1 and the second wireless communication apparatus 2. Communication is made in the same manner as described below between the first and third wireless communication apparatuses 1 and 3 as well as between the second and third wireless communication apparatuses 2 and 3.

A wireless communication apparatus as an access point transmits a broadcast signal (for example, a beacon signal). In order to make connection simpler and more efficient than a method of performing random backoff control, the present wireless system performs communication as follows.

When signal transmission is performed, a control signal to start connection between the wireless communication apparatuses, such as a connection request signal (Connect Request), is transmitted/received, for example by using random backoff control. After establishment of connection, a shorter signal transmission interval is given to an initiator than that to a responder. In this manner, a collision between the initiator and the responder can be avoided and an opportunity to transmit a signal can be entitled preferentially to the initiator even without random backoff control.

FIG. 2 shows an example of asymmetrical access by one-to-one wireless communication. Different signal transmission intervals are respectively set in individuals of the wireless communication apparatuses. This figure shows a case that the signal transmission interval for the initiator is set to an IFS, the signal transmission interval for the responder is set to a RIFS, and IIFS<RIFS is given. In this case, if an initiator has a data frame, frame transmission can be performed at a short signal transmission interval. On the other side, even if a responder has a data frame, an IIFS timer goes to timeout during counting by a RIFS timer and an initiator starts transmission, thereby causing a problem that a responder can therefore not transmit a frame. In particular, when a protocol of requesting an acknowledgement frame or a control frame from a responder is carried out in a higher layer, transmission of such a frame is delayed, which involves in reduction of a throughput of the whole system.

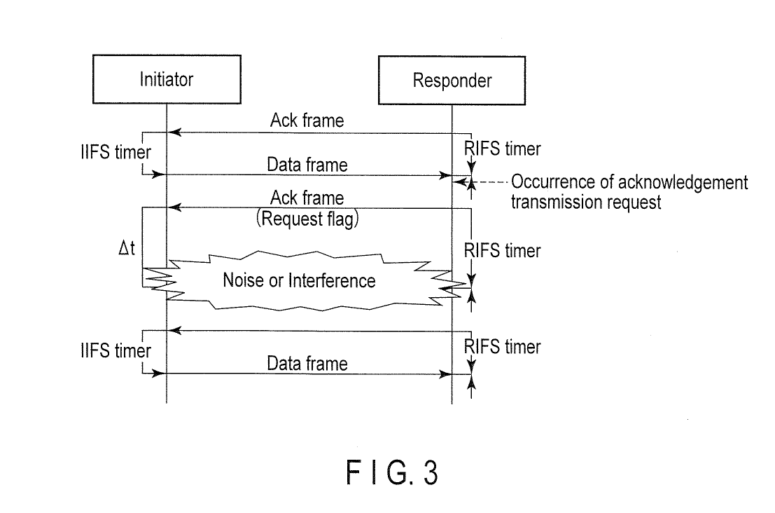

Next consideration will be taken into a case that an acknowledgement frame transmission request is notified to a wireless communication apparatus as a communication partner. The wireless communication apparatus which receives the notification stops frame transmission for a constant period. FIG. 3 shows a case that frame transmission is suspended for a constant period expressed by Δt.

A responder comprises a buffer for TCP DATA and a buffer for TCP ACK in the CNL. Header information of an IP layer and that of a TCP layer in a transmission frame are analyzed. Depending on an analysis result thereof, any of buffers is selected and the frame is inserted. When a transmission frame exists in the buffer for TCP ACK, a request flag is inserted in a response frame (ACK frame in the figure) transmitted thereafter. The initiator which receives the response frame in which the request flag is inserted suspends transmission for a constant period expressed by Δt. The responder transmits a data frame (Data frame in the figure) which includes an acknowledgement frame in a frame body after a RIFS timer. In the mechanism as described just above, when there is influence from interference or noise as in the example shown in FIG. 3, a problem may occur in that a responder to which an acknowledgement is to be transmitted misses a preferential transmission opportunity, i.e., an acknowledgement frame cannot be transmitted within Δt.

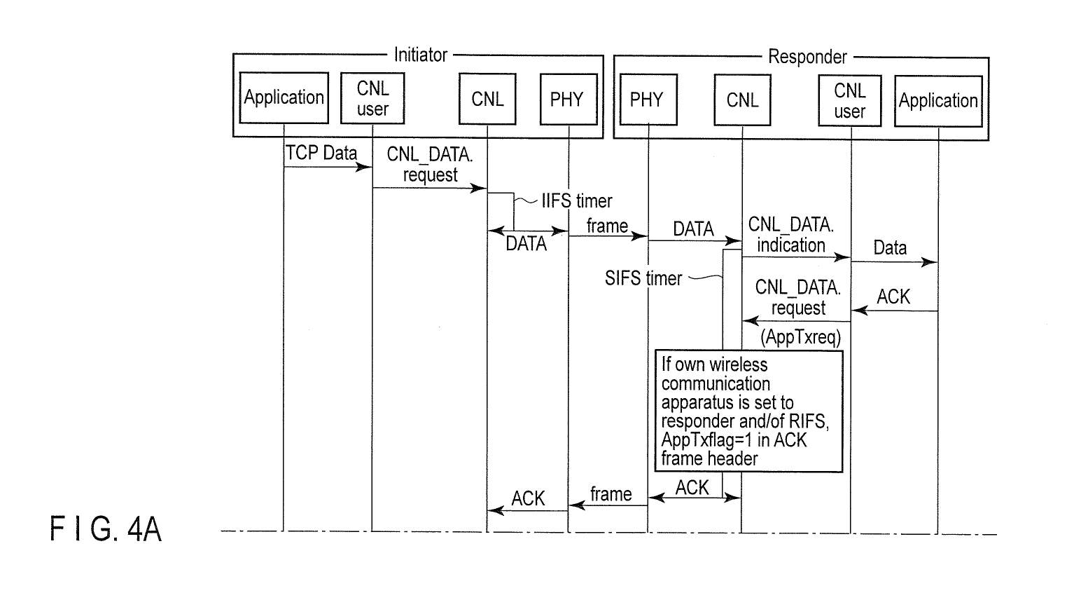

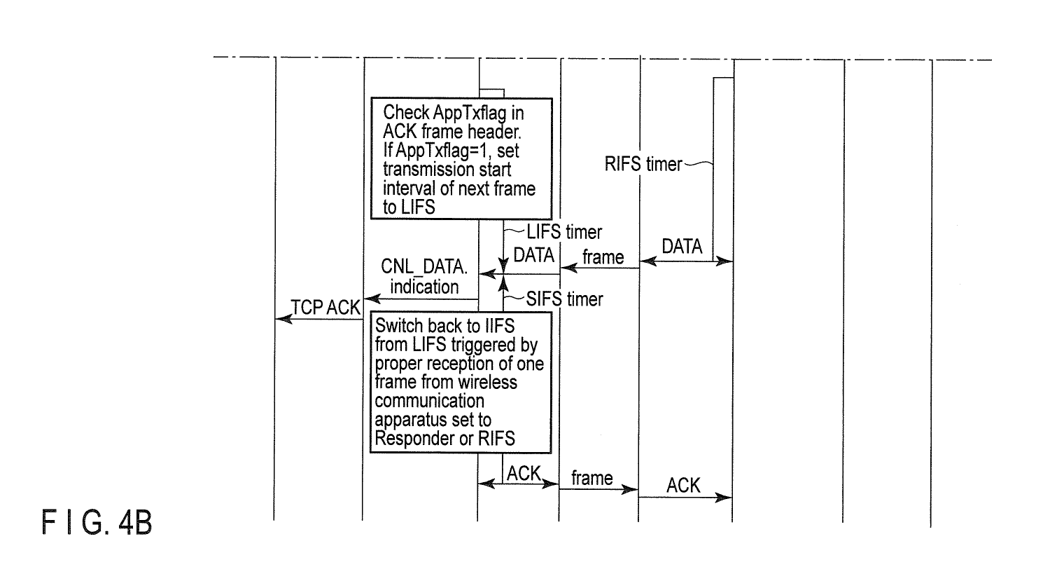

FIGS. 4A and 4B show a sequence of communication control according to the first embodiment. Each of the initiator and responder shown in this figure is configured by a physical layer (PHY), a CNL, a CNL user, and an application layer (Application). The PHY is supposed to be the second or four layer of the OSI reference model. The CNL performs transmission/reception of a data frame and a response frame through a network and is supposed to be the fifth layer of the OSI reference model. The CNL user performs control between the application layer and the CNL. The present embodiment is not influenced even when any other layer exists between the CNL user and the application layer or even when the application layer exists in a part of the CNL user.

FIGS. 4A and 4B are equivalent to an example of performing transmission/reception of data of a TCP/IP protocol, based on the ECMA-398 standard. In order to perform a processing based on the present embodiment, one bit of reserve (spare) bits of a frame header is used as an AppTxReq bit. Hereinafter, this notification bit is expressed as “AppTxflag”.

As shown in the figure, a transmission request (CNL_DATA.request) is outputted to the CNL from the CNL user with respect to data (TCP Data) from the application layer. The CNL starts an IIFS timer in response to input of a transmission request or starts the IIFS timer beforehand from a previous time point of terminating transmission/reception. A data (DATA) frame is outputted and a transmission instruction is given from the CNL to the PHY so as to start data transmission from the PHY upon timeout of the IIFS timer. The PHY starts data frame transmission at a timing controlled by the CNL.

On the other side, in a responder, the CNL performs a decoding processing on and error detection from received data. Upon proper reception, CNL_DATA.indication is outputted to the CNL user from CNL. The CNL user outputs a received frame body part (TCP Data) notified to the application layer by the CNL_DATA.indication. Next, a frame (TCP ACK) which sets the TCP frame header to ACKflag=1 is outputted to the CNL user from the application layer of the responder. If ACKflag=1 is satisfied in the CNL user, AppTxreq is inserted into the CNL_DATA.request and is outputted to CNL.

If an own wireless communication apparatus is a responder and is set to the RIFS, the CNL sets the AppTxflag of a response frame header to 1 and instructs the PHY to transmit a frame. If the own wireless communication apparatus is an initiator and is set to RIFS by temporarily transferring a priority to a responder and if CNL_DATA.request includes AppTxreq, the AppTxflag is set to 1 in the header of a response frame (ACK) and the PHY is instructed to transmit a frame. A response frame is transmitted in a SIFS shorter than the IIFS and RIFS (refer to ECMA-398).

The initiator which has received the response frame checks AppTxflag in the response frame header. If the AppTxflag is 1, the initiator changes a transmission start interval of a next frame (or extended in other words) to a Long Interframe Space (LIFS) from the IIFS. However, if the frame transmitted by the initiator needs to be retransmitted as a result of a frame reception processing by the initiator, a retransmission processing is performed in the IIFS, and the LIFS is changed to the IIFS after determining that retransmission is not needed thereafter.

The value of the LIFS needs to be set to a length not shorter than “RIFS timer+slot+TxRxSw timer” in consideration of at least the RIFS timer, a channel busy detection period (slot), and a period (TxRxSw timer) required for switching transmission/reception, since the frame transmitted after timeout by the wireless communication apparatus being set to RIFS needs to be able to be received during the LIFS.

According to specs of the ECMA-398, content of CNL_DATA.request includes only a CSDU Profile ID (PID), a Payload length, and a Data Payload. Therefore, there can be two methods as described below for notifying the foregoing AppTxreq. In the first one of the methods, 2 is additionally available as a PID although a PID can be set only to 0 or 1 according to the present specs. 2 is set for AppTxreq. In the remaining one method, AppTxreq is added as an element of the CNL_DATA.request, in addition to the three elements described above. In this case, AppTxreq=1 is set when TCPACK is requested.

Descriptions to FIGS. 4A and 4B have been made above with reference to an example of performing data transmission/reception according to a TCP/IP protocol. The present embodiment is performed in the same processing flow as in FIGS. 4A and 4B even when a DTCP or DTCP/IP protocol is used in a higher layer in consideration of application to image transfer. For example, the DTCP/IP provides a mechanism named Content Key Confirmation, and a confirmation request for a present key needs to be issued from the side of a responder to the side of an initiator for each constant time period. Therefore, at the time of requesting the confirmation for a key, a control frame is outputted as a transmission request from the application layer on the side of the responder to the CNL user layer. A response thereto is made by transmitting CNL_DATA.request including an AppTxreq flag from the CNL user layer. The responder transmits a response frame including AppTxflag added.

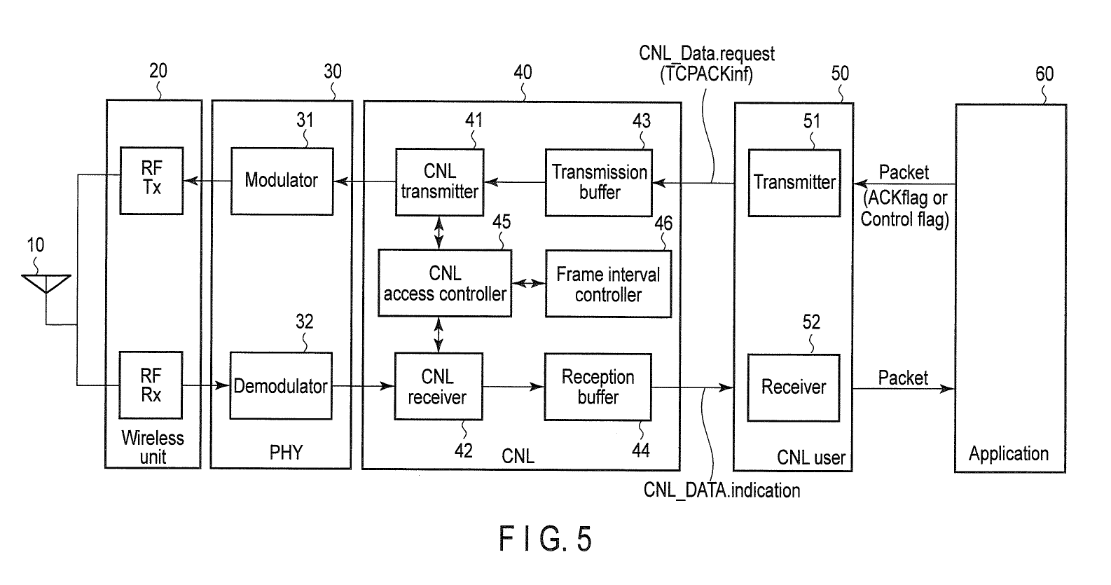

Next, FIG. 5 shows an example configuration of a wireless communication apparatus according to the present embodiment. Although the initiator and the responder transmit different signals at different timings, the initiator and responder can be constructed in the same hardware configuration as each other. Therefore, both the initiator and the responder will be described with reference to FIG. 5. The wireless communication apparatus of FIG. 5 is configured by an antenna 10, a wireless unit 20, a PHY30, a CNL40, CNL user 50, and an application 60. The PHY 30 comprises a modulator 31 and a demodulator 32. The CNL 40 comprises a CNL transmitter 41, a CNL receiver 42, a transmission buffer 43, a reception buffer 44, a CNL access controller 45, and a frame interval controller 46. The CNL user 50 comprises the transmitter 51 and the receiver 52.

Operation of the wireless communication apparatus at signal transmission will be described first. A packet outputted from the application 60 is stored into the transmission buffer 43 of the CNL 40 by CNL_DATA.request after a padding bit, if needed, is added by the CNL user 50. The transmission buffer 43 outputs data from inside the buffer to the CNL transmitter 41 in a stored order, in accordance with an instruction from the CNL transmitter 41. The CNL transmitter 41 performs an addition processing of adding a CNL header, and generates a frame. The generated frame is outputted to the modulator 31. The modulator 31 generates a physical frame by performing a coding processing, a modulation processing, and an addition processing of adding a physical header, to generate a physical frame. The wireless unit 20 generates a transmission signal by performing a D/A conversion processing, an up conversion processing, etc., on the physical frame, and transmits the signal through the antenna 10. In FIG. 5, blocks which perform the processing of adding a CNL header and generate a frame are totally referred to as the CNL transmitter. Alternatively, the CNL transmitter 41, the modulator 31, and a part of the wireless unit 20 having a transmission function in FIG. 5 may be totally referred to as a transmitter or a transmission unit.

A next description will be made of operation of the wireless communication apparatus when receiving a signal. A signal received through the antenna 10 is subjected to processings of down conversion and A/D conversion in the wireless unit 20, and are thereby converted into a physical frame. The demodulator 32 generates a frame by performing a demodulation processing and an analysis processing for a physical header on the physical frame. The CNL receiver 42 performs a processing of analyzing the CNL header of the frame. If a received signal is a signal transmitted from a communication partner of the own wireless communication apparatus and if there is no error in reception of the signal, the CNL receiver 42 outputs data to the CNL user 50 by CNL_DATA.indication. In FIG. 5, blocks which perform a processing of analyzing a CNL header and generate data are totally referred to as the CNL receiver. Alternatively, the receiver 42, the demodulator 32, and a part of the wireless unit 20 having a reception function in FIG. 5 may be totally referred to as a receiver or a reception unit as a whole.

Information indicating whether the own wireless communication apparatus is an initiator or a responder or information indicating whether the own wireless communication apparatus is set to the IIFS or RIFS where a priority is transferred between an initiator and a responder is retained by the CNL access controller 45 or the frame interval controller 46.

In the wireless communication apparatus according to the present embodiment, a frame inputted to the CNL user 50 is an acknowledgement frame or a control frame requested from a higher layer, AppTxreq information is inserted into the CNL_DATA.request outputted to the transmission buffer 43 of the CNL 40 from the transmitter 51.

The CNL 40 checks AppTxreq in the transmission buffer, and a setting of a frame transmission start interval for the own wireless communication apparatus when staring the transmission processing. If the own wireless communication apparatus is a responder, if AppTxreq=ON (for example, 1) is given, and if the RIFS is set, the AppTxflag of a response frame header is set to ON (for example, 1). If the own wireless communication apparatus is an initiator and if the RIFS is set, the AppTxflag of a response frame header is also set to ON (for example, 1).

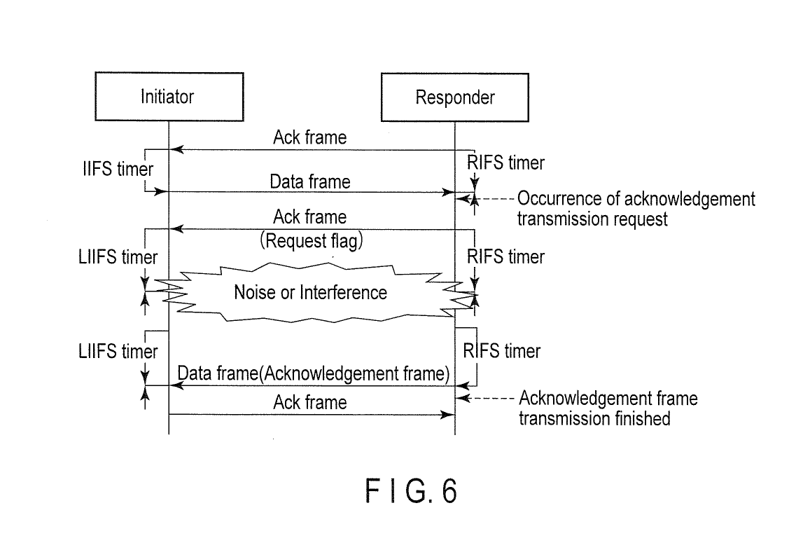

On the other side, when a response frame whose AppTxflag is ON is found to have been received, as a result of analyzing a received frame, the CNL receiver 42 notifies the frame interval controller 46 of the result. The frame interval controller 46 changes the transmission start interval of a next frame into the LIFS from the IIFS and retains the setting of the LIFS until at least one frame is received properly. After properly receiving a frame, the foregoing setting is returned to the IIFS from the LIFS. FIG. 6 shows an example at the time of interfering insertion where the mechanism of the present embodiment is employed. If noise or interference takes place in the course of starting the RIFS timer and trying transmission, the initiator resets the LIFS timer and the responder resets the RIFS timer at the timing when influence of the noise or interference ceases. As a result, the responder can perform transmission upon timeout of the RIFS timer.

Thus, in the wireless communication apparatuses according to the first embodiment, an initiator changes a timer setting from the IIFS to the LIFS at a desired timing of transmitting an acknowledgement frame of TCP/IP, thereby allowing a responder to transmit a frame in the RIFS. Accordingly, a TCP/IP throughput can be improved. Further, a relationship of RIFS<LIFS can be maintained until a wireless communication apparatus set to the RIFS can perform transmission and reception of an acknowledgement frame of desired TCP. Therefore, even if interference and noise cuts in after transmission of a request, the wireless communication apparatus set to the RIFS can transmit an acknowledgement frame after influence thereof ceases.

### Second Embodiment

The first embodiment discloses an example in which an initiator or a wireless communication apparatus set to an IIFS changes a transmission start interval of an immediately subsequent data frame from the IIFS to a LIFS when a response frame including AppTxflag=ON is received. On the other side, timers, such as the IIFS, RIFS, and LIFS, each need to start at a timing, as an origin point, of finishing transmission/reception of a frame on a wireless channel. Therefore, in order to perform a processing as described above, an initiator or a terminal set to the IIFS needs to start SIFS, IIFS, and LIFS timers when reception of a frame is finished, and also needs to cancel unrequired timers as a result of analyzing a received frame.

Although depending on frequency of changes from the IIFS to the LIFS, the processing of performing such a change for each time may be much complicated. Therefore, in the second embodiment, if an initiator includes AppTxflag=1 in FIGS. 4A and 4B, frame transmission is performed for an immediately subsequent data frame after an IIFS in accordance with a presently set IIFS timer. When reception of a response frame thereto on a wireless channel is finished, a LIFS timer is set.

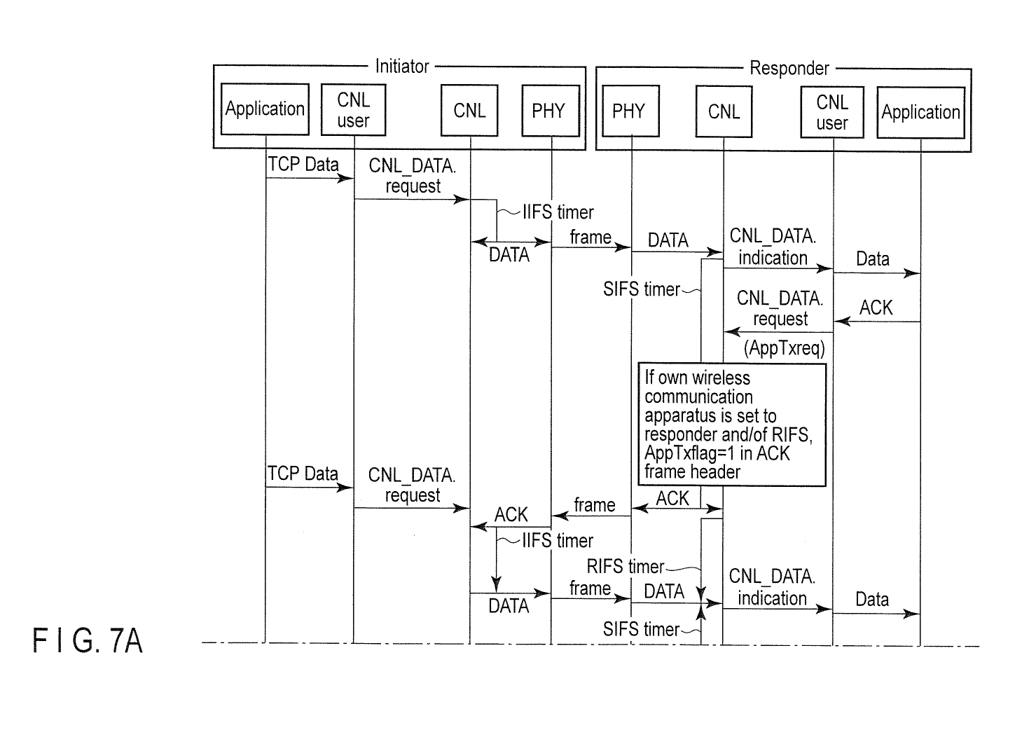

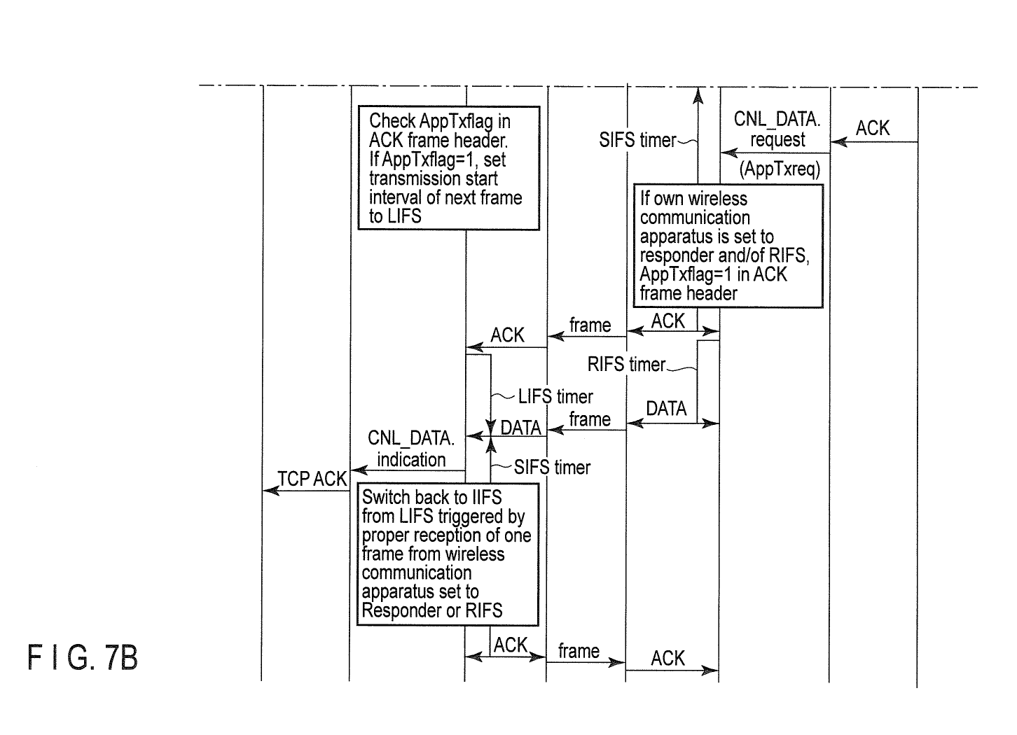

FIGS. 7A and 7B show a sequence of communication control according to the present embodiment. Although the sequence is basically the same as that of processings in the first embodiment, a timer setting at the time of receiving a response frame including AppTxflag=ON differs from the first embodiment. In order to simplify descriptions in the first embodiment, the sequence in FIGS. 4A and 4B shows that a CNL sets only a LIFS timer after finishing reception of an ACK frame. In actual, as described above, whether AppTxflag exists or not cannot be determined at the timing of finishing reception of an ACK frame on a wireless channel due to a delay of a frame decode processing. Therefore, setting is required for at least IIFS and LIFS timers.

On the other side, in the sequence of FIGS. 7A and 7B, setting is performed only for an IIFS timer when the first response frame including AppTxflag=ON is received. If transmission data exists in an initiator as shown in FIG. 6 in accordance with the setting, frame transmission is performed. Here is disclosed an example that a responder transmits a response frame including AppTxflag=ON also when the second frame is received. However, a notification was already made when the first frame was received, and AppTxflag is not mandatory here. In an IIFS, the initiator changes a frame transmission start interval from the IIFS to the LIFS by a frame interval controller 46 after frame transmission.

Thus, among the wireless communication apparatuses according to the second embodiment, a wireless communication apparatus which is set to a responder or the RIFS can require more or less longer time until transmission succeeds since a TCPACK transmission request issues. However, setting and control of timers can be simplified in the initiator. The first and second embodiments have been described as a method in which, if a request is made from a responder, a timer value for an initiator is changed to the LIFS from the IIFS. Aside from the method, transfer of a priority to exchange settings of signal transmission intervals (IIFS, RIFS) between the initiator and the responder may be considered. In the present embodiment, if there is a request from a responder, a processing of exchanging the IIFS and RIFS settings may be performed. However, for only transmission of TCPACK or transmission of a control frame by a DTCP protocol, frame transmission of a small frame size is sufficient. It is therefore effective to maintain the LIFS setting until transmission/reception of the frame is finished properly.

### Third Embodiment

The first and second embodiments disclose an example that if an own wireless communication apparatus is a responder and is set to the RIFS in the CNL or if the own wireless communication apparatus is an initiator and is set to the RIFS by temporarily transferring a priority to a responder and if CNL_DATA.request includes AppTxreq, the AppTxflag in the response frame header is always set to ON.

On the other side, if the CNL transmitter 41 starts a RIFS time at the time when CNL_DATA.request including AppTxreqA is stored into a transmission buffer of the CNL and if frame transmission is possible after a RIFS without cancelling the RIFS timer at the time of starting a transmission processing, AppTxreq needs not always be notified to the initiator.

Hence, in the present embodiment, a responder starts a RIFS timer immediately after inputting CNL_DATA.request including AppTxreq to a CNL. In addition, a CNM access controller 45 or a frame interval controller 46 retains whether the RIFS timer is canceled by receiving a frame from an initiator or not or how many times the RIFS timer is canceled. Based on the information described above, whether AppTxreq is to be notified to the initiator or not is determined. For example, where the determination is made depending only on whether cancellation exists or not, AppTxflag is added only if the RIFS is set, if CNL_DATA.request includes AppTxreq, and if the RIFS timer is cancelled.

Thus, among the wireless communication apparatuses according to the third embodiment, a responder determines whether frame transmission of TCPACK is possible in a RIFS or not, and notifies AppTxreq only if the frame transmission is not possible. In this manner, processings by the initiator are simplified.

### Fourth Embodiment

In the first to third embodiments, an initiator changes the LIFS freely as required by AppTxreq from a responder, and thus achieves transmission prioritizing the responder. On the other side, the present embodiment is configured such that the CNL 40 of an initiator determines whether a setting is to be changed for the LIFS or not by using not only information from a request from a responder but also information from a CNL user of an own wireless communication apparatus.

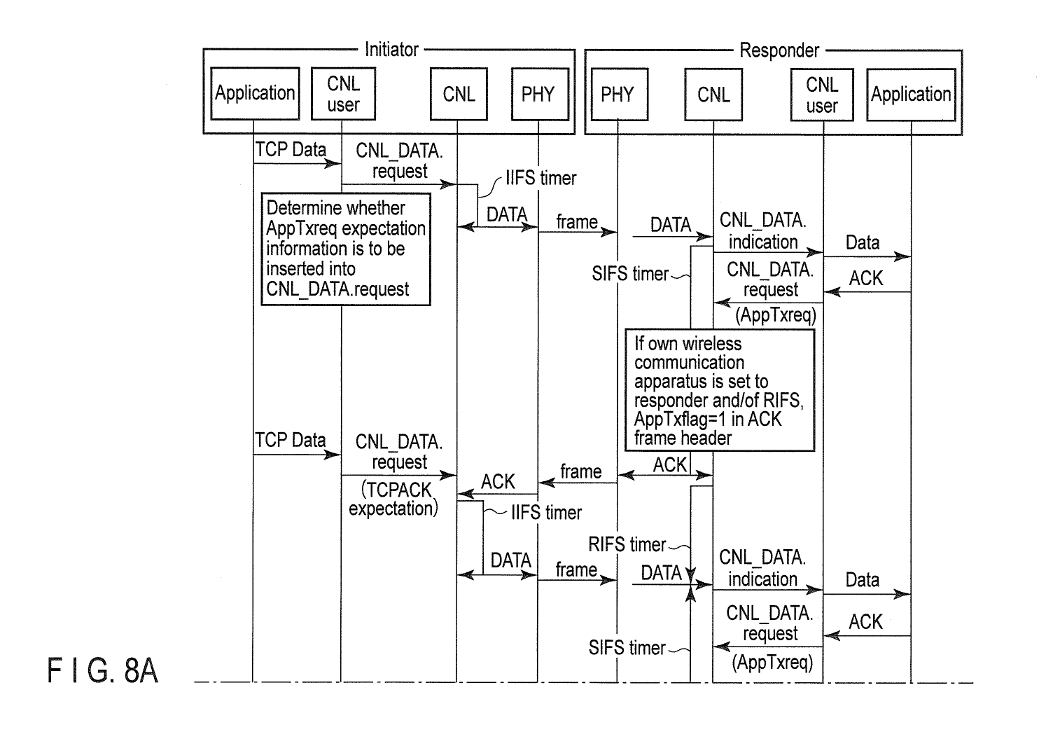

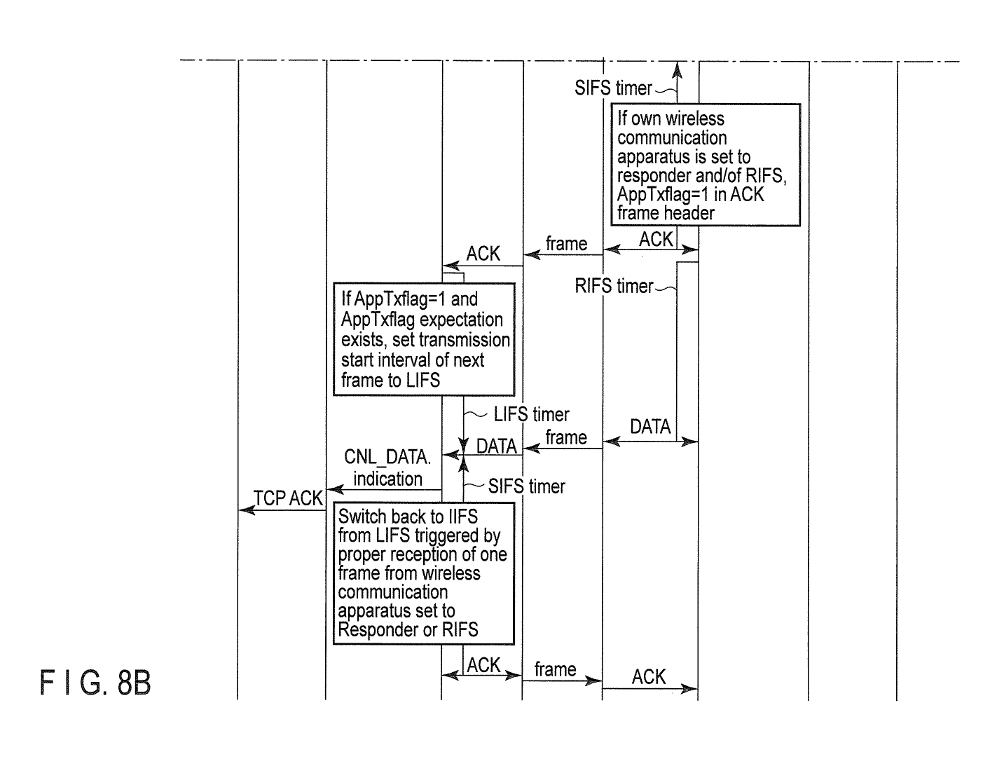

FIGS. 8A and 8B show a sequence of communication control according to the present embodiment. Processings performed by the responder are the same as those in the first to third embodiments, and will therefore be omitted herefrom. Processings by an initiator according to the present embodiment will now be described with reference to FIGS. 8A and 8B. At first, the CNL user determines whether AppTxreq expectation information is to be inserted into a CNL_DATA.request signal to be outputted to a CNL or not. The AppTxreq expectation information means that a response frame is expected to be received from an application of a responder.

When TCP/IP transmission/reception is performed, AppTxreq expectation information=ON may be constantly set. Alternatively, in case of TCP/IP and if a TCPACK reception timing can be expected from transmission/reception concerning a window size in a connection processing when starting TCP/IP communication, AppTxreq expectation information=ON may be set at a timing close to the TCPACK reception timing. Otherwise, if DTCP or DTCP/IP is performed, in order to receive a response frame from a responder for each constant interval, AppTxReq expectation information=ON may be set with reference to the constant interval as a guide.

A manner of inserting AppTxReq expectation information into CNL_DATA.request is supported by changing a setting of present specs of a PID or by adding AppTxreq, as described in the first embodiment above. Also at the time of insertion by an initiator shown in the present embodiment, PID=2 and/or AppTxreq=1 may be adopted as in the first embodiment, or consideration may be taken into a setting, for example, PID=3 or AppTxreq=2. In the latter case, a processing is available without checking whether an own wireless communication apparatus is set to an IIFS. A CNL determines whether AppTxreq expectation information is inserted into CNL_DATA.request from the CNL user or not, and retains the information in a CNL access controller 45 or a frame interval controller 46. At the time of AppTxflag=ON included in a CNL header of a response frame received from the responder, the initiator determines whether the TCPACK expectation information exists or not.

If AppTxreq expectation information exists, the setting is changed from the LIFS to the IIFS. If AppTxreq expectation information does not exist, the IIFS is continuously set, and frame transmission/reception is continued.

Thus, the wireless communication apparatuses according to the fourth embodiment can prevent reduction in efficiency of an own wireless communication apparatus, which is caused by allowing frame transmission freely as requested from a responder.

### Fifth Embodiment

In the first to fourth embodiments, there is a presupposition that CNL_DATA.request inserted into the transmission buffer 43 of CNL of a responder is AppTxreq only. However, there are applications which suppose bidirectional data transmission/reception. In this case, there is a possibility that a request for so-called DATA which is different from AppTxreq comes as CNL_DATA.request of a responder. Hence, the present embodiment will now be described with reference to a processing when CNL_DATA.request of AppTxreq and CNL_DATA.request which is not AppTxreq exist mixed together in a responder.

As a measure to respond to a case that transmission requests accompanied by a plurality of CNL_DATA.request and transmission data are inputted to a transmission buffer, there is a method of making a determination depending on whether a CNL_DATA.request to be processed next is AppTxreq or not. Processings in this case are the same as those in the first to fourth embodiments, and descriptions thereof will therefore be omitted. In another method, whether AppTxreq exists or not is determined for each of all transmission requests accompanied by a plurality of CNL_DATA.request inputted to the transmission buffer. If CNL_DATA.request of AppTxreq and CNL_DATA.request which is not AppTxreq are mixed, frame transmission is performed with AppTxflag turned ON, which is included in the CNL header of a response frame, even when a data frame to be processed next in the CNL is CNL_DATA.request which is not AppTxreq.

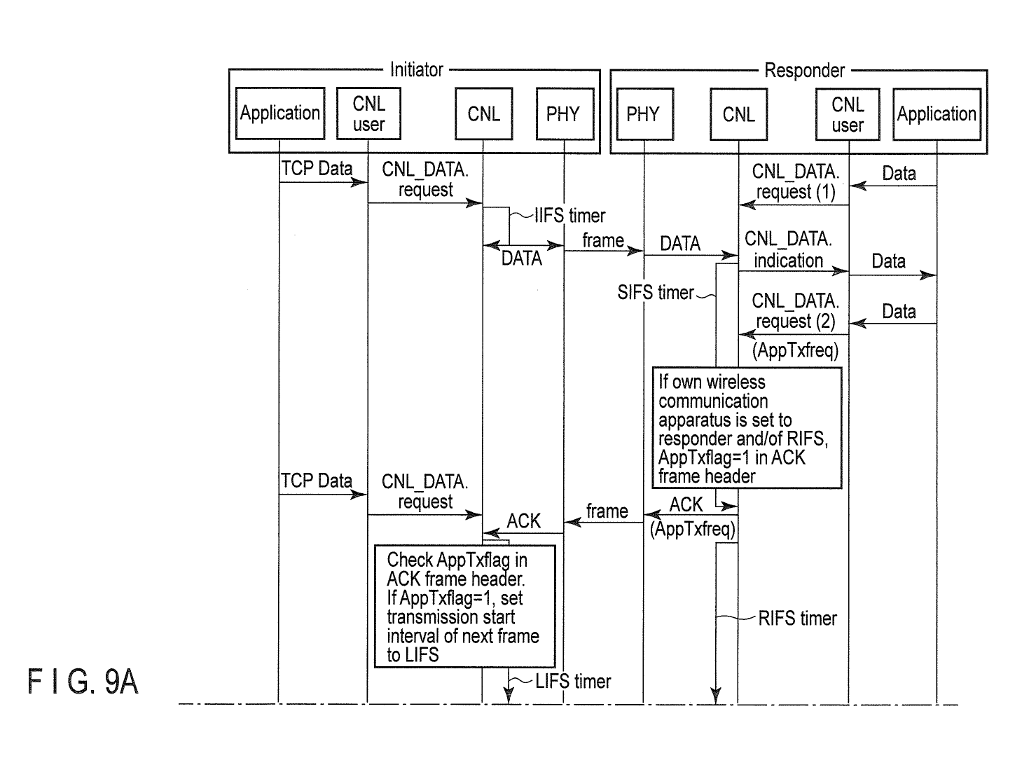

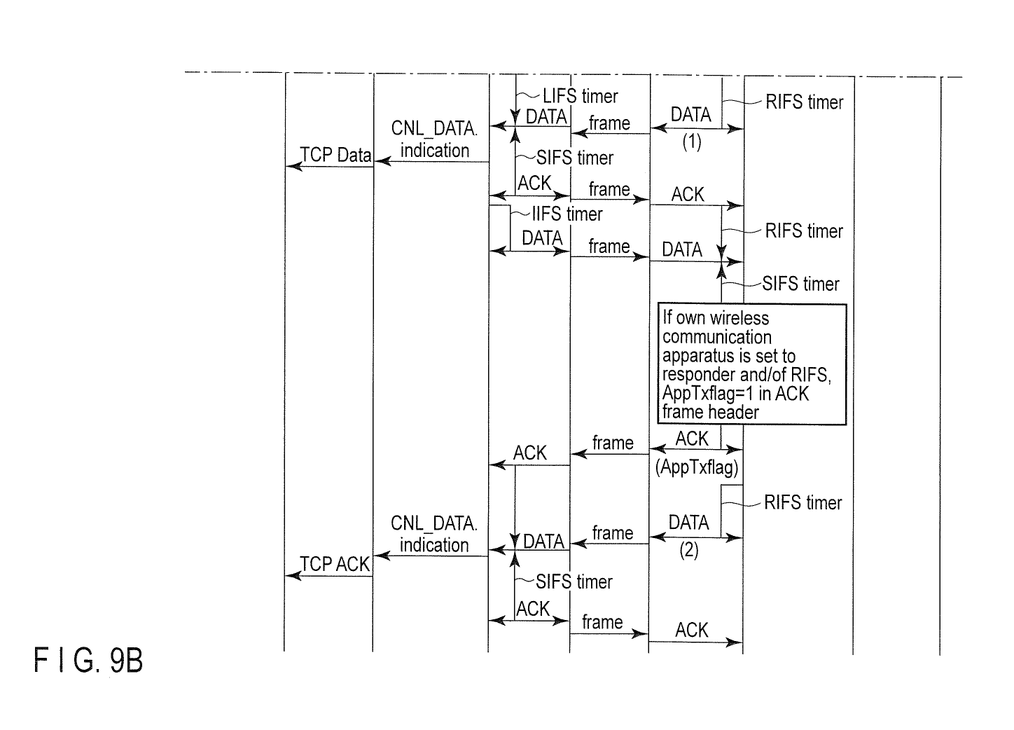

FIGS. 9A and 9B show a sequence of communication control according to the present embodiment. The example of FIGS. 9A and 9B shows a case that CNL_DATA.request of TCP DATA is set into a transmission buffer 43 of the CNL of a responder, and CNL_DATA.request of TCP ACK is inserted thereafter. Where a determination is made depending only on CNL_DATA.request to be processed next, as described in the foregoing first to fourth embodiments and in clauses just above, AppTxflag is not added when a response frame is transmitted. In this case, DATA cannot be transmitted before burst transmission in the IIFS from an initiator is finished, which obviously influences frame transmission of AppTxflag which is accumulated next in the transmission buffer.

Otherwise, where a determination is made depending on all items of CNL_DATA.request accumulated in the transmission buffer, the responder checks AppTxreq of all the data frames accumulated in the transmission buffer each time AppTxreq is transmitted. The responder performs frame transmission with CNL header AppTxflag of a response frame turned ON until transmission of AppTxreq from all the data frames accumulated in the transmission buffer ends.

Thus, the wireless communication apparatuses according to the fifth embodiment can advance a transmission timing of TCP ACK to come earlier, as a result of making a determination about AppTxreq for all requests accumulated in the transmission buffer, when CNL_DATA.request of AppTxreq and CNL_DATA.request which is not AppTxreq are mixed in a responder.

### Sixth Embodiment

The fifth embodiment discloses an example in which transmission of TCP ACK is facilitated by inserting AppTxflag when CNL_DATA.request of AppTxreq and CNL_DATA.request which is not AppTxreq are mixed in a responder. On the other side, efficiency can be improved more by adopting priority transfer of exchanging settings of signal transmission intervals (IIFS, RIFS) between an initiator and a responder when transmission requests other than AppTxreq are accumulated in a transmission buffer in a responder. The present embodiment describes a mechanism of transmitting a response signal with a switch request flag added, when CNL_DATA.request which is not AppTxreq is received together with AppTxflag from a responder.

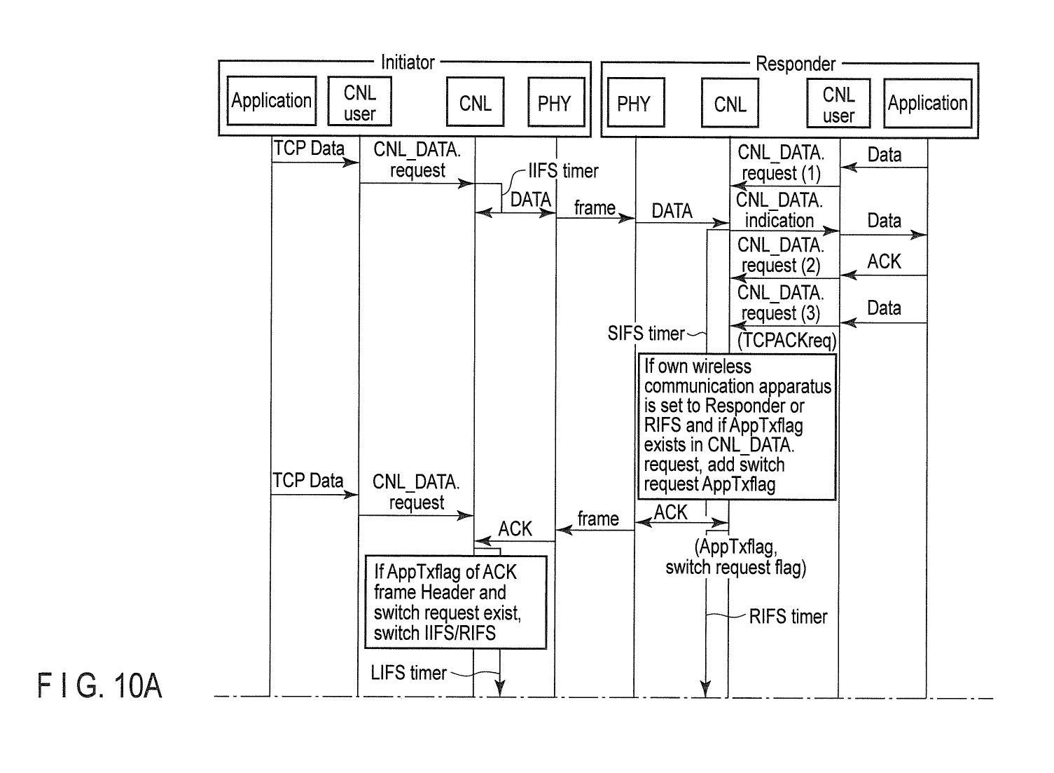

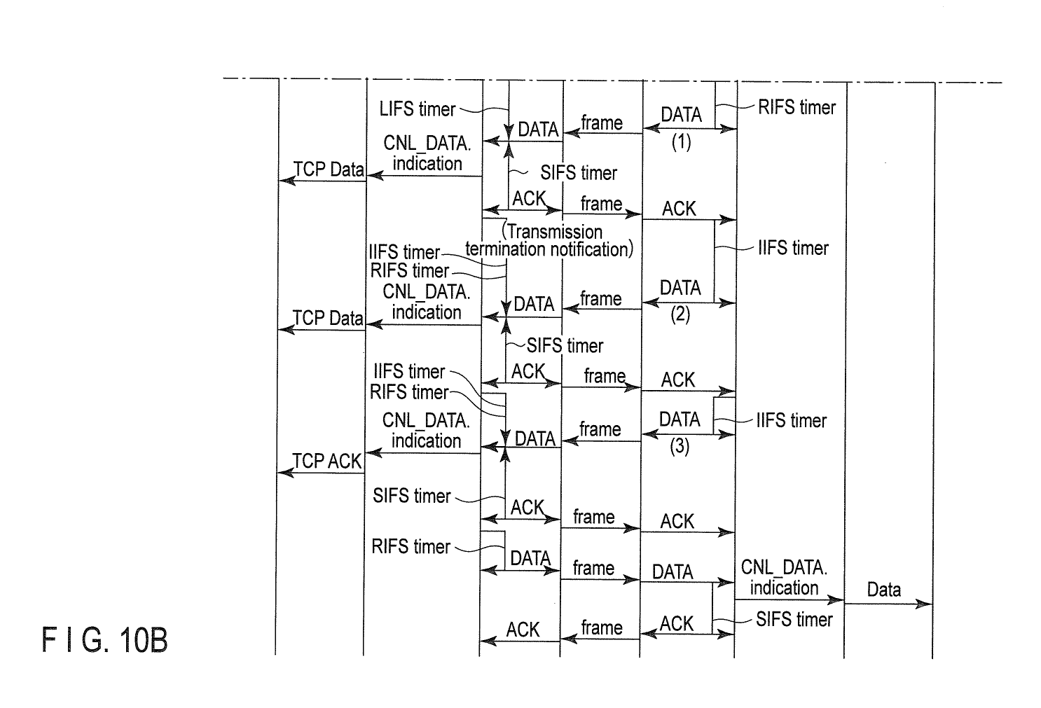

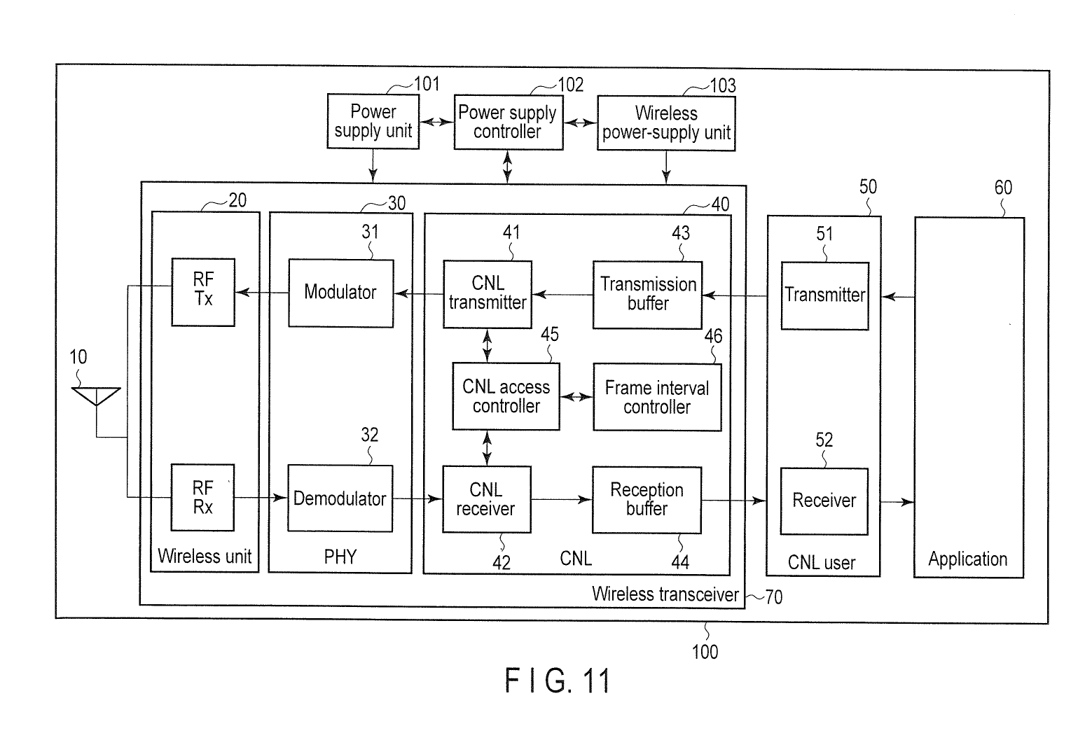

FIGS. 10A and 10B show a sequence of communication control according to the present embodiment. The example of FIGS. 10A and 10B shows a case that a plurality of transmission requests including AppTxreq and other transmission requests are accumulated in a CNL transmission buffer of a responder. In this case, a responder transmits a switch request flag added, together with AppTxflag of a response frame header. On the other side, an initiator, which has received a response frame including AppTxflag and a switch request flag, determines whether IIFS/RIFS switching is to be performed or not in consideration of a state of an own transmission buffer 43. If IIFS/RIFS switching is performed and if a determination is made to temporarily give a transmission period in an IIFS to a responder, a transmission termination notification is transmitted, inserted in a data frame. If the responder transmits a response frame including AppTxflag and a switch request flag and receives a transmission completion notification thereto, the responder manages information thereof by a frame interval controller. In the above case, a setting is changed from the RIFS to the IIFS, and next frame transmission is performed based on an IIFS timer.

In the example of FIGS. 10A and 10B, at the timing of receiving a response frame including AppTxflag and a switch request flag, a transmission request is included in the transmission buffer of the initiator. However, IIFS/RIFS switching is determined to be performed here. Another determination example of the initiator is, for example, to provide a TCPACK transmission opportunity in the LIFS without performing the IIFS/RIFS switching if a transmission request exists in the transmission buffer, and to perform the IIFS/RIFS switching if no transmission request exists. There can be a method of determining whether the IIFS/RIFS switching is to be performed or not depending on a share of transmission requests in the transmission buffer. The latter case may be considered as follows. If the transmission request share in the transmission buffer is not greater than the half, for example, the IIFS/RIFS switching is performed. If the transmission request share exceeds 75%, the setting is switched again to the IIFS, and thereafter, the LIFS is adopted.

### Seventh Embodiment

The present embodiment discloses a configuration of comprising an antenna 10 in a wireless communication apparatus in the same configuration as the wireless communication apparatus 1 shown in FIG. 5. Thus, the wireless communication apparatus can be configured as a single apparatus comprising even an antenna since the wireless communication apparatus is configured to comprise the antenna 10. Accordingly, a mount area can be reduced to be small. As shown in FIG. 6, the antenna 10 is shared by a transmission processing and a reception processing. Thus, the wireless communication apparatus can be downsized by sharing an antenna between the transmission processing and the reception processing.

### Eighth Embodiment

The present embodiment discloses a configuration of additionally comprising a bus 10, a processor unit, and an external interface in the wireless communication apparatus 1 shown in FIG. 5. Firmware operates in the processor unit. The processor unit, bus, and external interface may be included in an application 60 or may be independent from the application 60. Since the wireless communication apparatus is thus configured to comprise firmware, functions of the wireless communication apparatus can be easily changed by rewriting firmware.

### Ninth Embodiment

The present embodiment discloses a configuration of additionally comprising a clock generator in the wireless communication apparatus 1 shown in FIG. 5. The clock generator is connected to a wireless transceiver 70 and is externally outputted from an output terminal, where the wireless unit 20, PHY30, and CNL40 in FIG. 5 collectively form the wireless transceiver 70. Thus, a clock generated inside a wireless communication apparatus is outputted to outside, to operate a host by an externally outputted clock. In this manner, the host side and the wireless communication apparatus side can be operated in synchronization.

### Tenth Embodiment

FIG. 11 schematically shows a wireless communication apparatus 100 according to the present embodiment. The wireless communication apparatus 100 additionally comprises a power supply unit 101, a power supply controller 102, and a wireless electric-power supply unit 103, each of which is connected to a wireless transceiver 60, in the configuration of the wireless communication apparatus 1 of FIG. 5. With the configuration of the tenth embodiment as described above, operation at reduced power consumption is available with the power supply controlled.

### Eleventh Embodiment

In the present embodiment, a NFC (Near Field Communications) transceiver is comprised in the configuration of the wireless communication apparatus 100 shown in FIG. 11. The NFC transceiver connects with a power supply controller 102 and a MAC processor 40 and may exist in an application 60 or may exist independently. By thus configuring the wireless communication apparatus to comprise the NFC transceiver, an authentication processing can be easily performed. Besides, by performing power supply control triggered by the NFC transceiver, power consumption is reduced during a waiting time.

### Twelfth Embodiment

The present embodiment discloses a configuration of additionally comprising a SIM card in the wireless communication apparatus 100 shown in FIG. 11. The SIM card connects with a MAC processor 40 and may exist in an application 60 or may exist independently. By thus configuring wireless communication apparatus to comprise a SIM card, an authentication processing can be easily performed

### Thirteenth Embodiment

The present embodiment discloses a configuration of additionally comprising a video compressor/expander in the eighth embodiment. The video compressor/expander connects with a bus. By thus configuring a wireless communication apparatus to comprise a video compressor/expander, transfer of compressed video images and expansion of received compressed video images can be performed easily.

### Fourteenth Embodiment

The present embodiment discloses a configuration of additionally comprising a LED unit in the wireless communication apparatus 1 shown in FIG. 5. By thus configuring a wireless communication apparatus to comprise the LED unit, a user can be easily notified of an operation state of the wireless communication apparatus.

### Fifteenth Embodiment

The present embodiment discloses a configuration of additionally comprising a vibrator in the wireless communication apparatus 1 shown in FIG. 5. By thus configuring a wireless communication apparatus to comprise the vibrator, a user can be easily notified of an operation state of the wireless communication apparatus.

### Sixteenth Embodiment

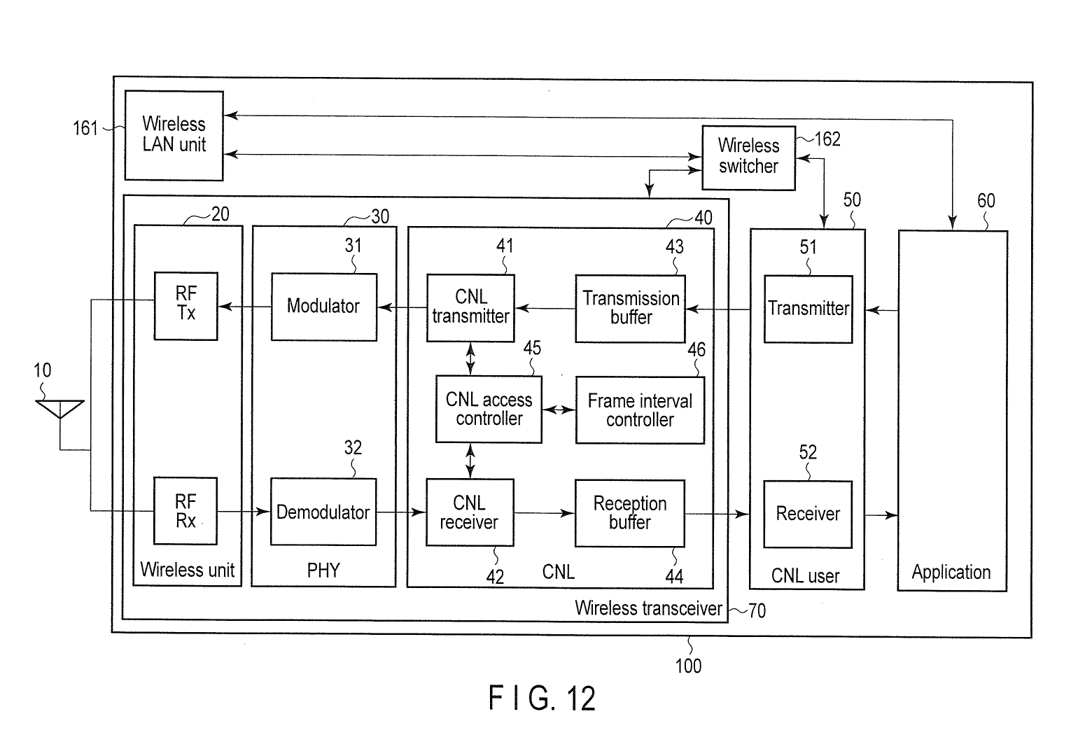

The present embodiment discloses a configuration of additionally comprising a wireless LAN and a wireless switcher in the wireless communication apparatus 1 shown in FIG. 5. FIG. 12 schematically shows a wireless communication apparatus 160 according to the present embodiment. In the wireless communication apparatus 160, a wireless LAN unit 161 and a wireless switcher 162 are added to the configuration of the wireless communication apparatus 1 of FIG. 5. The wireless switcher 160 is connected to a wireless transceiver 60, a CNL user 50, and the wireless LAN unit 161. By thus configuring the wireless communication apparatus to comprise the wireless LAN unit, communication by the wireless LAN and communication by the wireless transceiver can be switched between each other depending on circumstances. A plurality of channels can be used in a millimeter wave band. However, if every channel interferes too much with any other system to perform desired transmission/reception, ability to switch to communication by the wireless LAN is desirable. Here, the wireless LAN to be switched to may be of the IEEE-802.11a, b, or g, using a different frequency band from that of a present wireless system or may be of 802.11ad using the same frequency band as the present wireless system. Additionally, the wireless LAN unit may be configured to comprise an original transmission/reception antenna. Otherwise, an antenna may be shared in case of the wireless LAN using the same frequency band as the present wireless system.

### Seventeenth Embodiment

The present embodiment discloses a configuration of additionally comprising a switch (SW) in the configuration of the sixteenth embodiment. The switch is connected to each of a wireless transceiver 60, a wireless LAN unit 161, and a wireless switcher 162. By thus configuring the wireless communication apparatus to comprise the switch, communication by wireless LAN and communication by the wireless transceiver can be switched between each other depending on circumstances while sharing an antenna.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus used for asymmetrical communication, in which frame transmission at a first interval and frame transmission at a second interval longer than the first interval are performed, comprising:
a receiver that receives a frame for which a flag requesting transmission of an acknowledgement is set;
an interval controller that changes the first interval to a third interval longer than the second interval in response to reception of the frame; and
a transmitter that performs frame transmission at the third interval.

2. The apparatus of claim 1, wherein after performing frame transmission at the third interval, the interval controller maintains the third interval until at least one frame is properly received.

3. The apparatus of claim 1, wherein after the frame is received and the frame transmission at the first interval is performed at least one time, the interval controller changes the first interval to the third interval.

4. The apparatus of claim 1, wherein when the frame transmission at the second interval is performed, the transmitter determines whether the frame for which the flag requesting the transmission of the acknowledgement is set is to be transmitted or not, in accordance with information indicating that a timer showing elapsed time from a start of the second interval has been cancelled before the timer goes into timeout or information indicating a number of times for which the timer has been cancelled.

5. The apparatus of claim 1, wherein if the interval controller receives information indicating expectation to receive the acknowledgement from a higher layer and if the frame is received, the interval controller changes the first interval to the third interval.

6. The apparatus of claim 1 further comprising a transmission buffer which stores a plurality of frames, transmission of which has been requested, wherein
if the flag requesting the transmission of the acknowledgement is set for at least one of the plurality of frames when the frame transmission at the second interval is performed, the transmitter transmits the plurality of frames with the flag set for every one of the plurality of frames.

7. The apparatus of claim 6, wherein the plurality of frames including a flag requesting exchange of settings of the first and second intervals between the wireless communication apparatuses.

8. A wireless communication apparatus used for asymmetrical communication, in which frame transmission at a first interval and frame transmission at a second interval longer than the first interval are performed, comprising:
a processor configured to receive a frame for which a flag requesting transmission of an acknowledgement is set, to change the first interval to a third interval longer than the second interval in response to reception of the frame, and to perform frame transmission at the third interval; and
a memory connected to the processor.

9. A wireless communication apparatus used for asymmetrical communication, which performs frame transmission at a first interval and frame transmission at a second interval longer than the first interval are performed, comprising:
an antenna;
a receiver that receives, through the antenna, a frame to which a flag requesting transmission of a acknowledgement is set;
an interval controller that changes the first interval to a third interval longer than the second interval in response to reception of the frame; and
a transmitter that performs frame transmission at the third interval through the antenna.

10. A wireless communication method used for asymmetrical communication, in which frame transmission at a first interval and frame transmission at a second interval longer than the first interval are performed, comprising:
receiving a frame for which a flag requesting transmission of an acknowledgement is set;
changing the first interval to a third interval longer than the second interval in response to reception of the frame; and
performing frame transmission at the third interval.
